(19) United States
(12) Patent Application Publication
(10) Pub. No.: US 2006/0055844 A1
(43) Pub. Date: Mar. 16, 2006

(54) Dark state light recycling film and display

(75) Inventor: Xiang-Dong Mi, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/939,656

(22) Filed: Sep. 13, 2004

(51) Int. Cl. G02F 1/1335

(52) U.S. Cl. 349/96

(57) ABSTRACT

A liquid crystal device display (20) has a backlight unit (56) for providing substantially unpolarized illumination, a rear polarizer (50b) disposed proximate the backlight unit (56) for receiving the incident substantially unpolarized illumination and transmitting substantially polarized illumination, a liquid crystal spatial light modulator for forming a display beam by selective, pixel-wise modulation of the polarization of the substantially polarized illumination, and a reflective polarizer (52a) disposed between the liquid crystal spatial light modulator and a front polarizer (50a), the reflective polarizer (52a) reflecting a portion of dark state light back toward the backlight unit (56).

### FIELD OF THE INVENTION

This invention generally relates to LCD displays using polarizers and more particularly relates to an LCD display using a reflective polarizer to recycle dark state light that otherwise is absorbed by the front polarizer of the LCD.

### BACKGROUND OF THE INVENTION

Conventional Liquid Crystal Device (LCD) displays form images by modulating the polarization state of illumination that is incident to the display surface. In a typical back-lit LCD display, an arrangement of polarizers is used to support the LCD modulation, including a rear polarizer, between the LCD and the light source, to provide polarized light to the LCD spatial light modulator and a front polarizer, acting as an analyzer. (By definition, the front polarizer is designated as the polarizer closest to the viewer.) In operation, each pixel on the display can have either a light state, in which modulated light that is aligned with the transmission axis of the front polarizer is emitted from the display, or a dark state, in which light is not aligned with the transmission axis of the front polarizer and is effectively blocked from emission.

Referring to FIG. 6, there is shown, in summary form, the behavior of key components of a display for handling incident polarized light to each pixel, showing the symbols and graphic conventions used in subsequent description. Orthogonal P- and S-polarization states are indicated by lines or circles, respectively, superimposed on arrows that indicate incident light direction. Transmission axes are similarly indicated by a double-sided arrow or a circle. An absorptive polarizer 50a, 50b, transmits polarized light that is aligned with its polarization axis and absorbs polarized light that is orthogonally oriented. By comparison, a reflective polarizer 52a, 52b transmits polarized light that is aligned with its polarization axis and reflects polarized light that is orthogonally oriented. An individual LC component 54a/54b modulates the incident display beam by modulating the substantially polarized illumination beam in pixel-wise fashion. Following the convention used in this specification, an off state LC component 54a rotates the polarization of incident light. An on state LC component 54b does not rotate the polarization of incident light. The general nomenclature “LC component”, as used in this disclosure, applies to a light-modulating element on the LCD spatial light modulator itself. The LCD spatial light modulator can be considered as an array of LC components 54a/54b.

There are two possible states for any pixel modulated by the LCD spatial light modulator: a dark state and a light state. In this application, the terms “dark state” and “light state” are used to describe the pixel state; the terms “on state” and “off state”, as noted above, refer to the polarization activity of the LC component itself, rather than to the pixel state that is represented.

It is significant to observe that the characteristics of each type of LCD spatial light modulator determine whether or not the on state of each LC component provides a dark state or light state to its corresponding pixel. As stated above, the examples illustrated in the present application use the following convention:
(i) an on state LC component 54b provides a dark state pixel;
(ii) an off state LC component 54a provides a light state pixel.
   However, the opposite pairing of on and off states to light and dark state pixels is also possible. For subsequent description in this application, except where specifically noted otherwise, the convention stated here and illustrated in FIG. 6 applies.

FIG. 1A shows a conventional arrangement of LCD display 10 with a front polarizer 50a, rear polarizer 50b, a backlight unit 56, a reflective film 57, with off state LC component 54a that converts S-polarization (circle) to p-polarization (line) (and, conversely, converts P-polarization to S-polarization). Unpolarized light is emitted from backlight 56. In this light state, only light having S-polarization is transmitted through rear polarizer 50b, through off state LC component 54a, and through front polarizer 50a.

FIG. 1B shows the same components as FIG. 1A for a dark state. Here, on state LC component 54b does not change the incident light polarization (that is, S-polarization remains S-polarization, P-polarization remains P-polarization). Light having s-polarization is transmitted through rear polarizer 50b. On state LC component 54b transmits this S-polarization light, which is then absorbed by front polarizer 50a, as indicated by symbol “X”.

The conventional arrangement of FIGS. 1A and 1B is workable, but constrains the overall amount of light that is available for display 10. Rear polarizer 50b absorbs light having p-polarization, effectively wasting this light energy. Ambient light does not impact the performance of this arrangement. Referring to FIG. 1C, it is seen that half of the ambient light is absorbed by front polarizer 50a. The other half of the ambient light goes through off state LC component 54a, which rotates the polarization, then through rear polarizer 50b. Some portion of this light may be reflected back by reflective film 57 for reuse. Referring to FIG. 1D, the dark state handling of ambient light is shown. Here, front polarizer 50a transmits only the light having P-polarization. On state LC component 54b does not change light polarization. Rear polarizer 50b then absorbs the ambient light not having s-polarization. In the dark state, then, ambient light effects are substantially diminished, with half of the light attenuated by front polarizer 50a and most of the other half attenuated by rear polarizer 50b.

As an attempt to increase the efficiency of display illumination, reflective polarizer 52b can be added to the group of supporting polarizers, as shown in FIGS. 2A-2D. Here, unpolarized light from backlight unit 56 goes to reflective polarizer 52b, which transmits light having one polarization (the S-polarization in the example of FIGS. 2A-2B) and reflects light having the orthogonal polarization. The reflected light component can be recycled, having its polarization state modified by backlight 56, by reflective film 57, or by some other device, such as a ¼ wave-plate or depolarization film, for example. Light state and dark state handling are performed in the same manner as was described with reference to FIGS. 1A-1D. In FIG. 2A, off state LC component 54a rotates the polarization of incident light and front polarizer 50a transmits light aligned with its transmission axis (that is, P-polarization light). In FIG. 2B, light having S-polarization is transmitted through rear polarization 50b. On state LC component 54b transmits this S-polarization light, which is then absorbed by front polarizer 50a, as indicated by symbol “X”.

FIGS. 2C and 2D show the impact of reflective polarizer 52b on incident ambient light. Ambient light having P-polarization is transmitted through front polarizer 50a and through off state LC component 54a or, conversely, through on state LC component 54b. Both rear polarizer 50b and reflective polarizer 52b transmit S-polarization light. Rear polarizer 50b absorbs P-polarization ambient light, which would be reflected from reflective polarizer 52b. In the dark state, ambient light effects are substantially diminished, with half of the light attenuated by front polarizer 50a and most of the other half attenuated by rear polarizer 50b.

The conventional arrangement using a reflective polarizer, as summarized in FIGS. 2A-2D, is described in a number of patent disclosures, including:
U.S. Pat. No. 6,661,482 entitled “Polarizing Element, Optical Element, and Liquid Crystal Display” to Hara;
U.S. Pat. No. 5,828,488 entitled “Reflective Polarizer Display” to Ouderkirk et al.;
U.S. Patent Application Publication 2003/0164914 entitled “Brightness Enhancing Reflective Polarizer” by Weber et al.; and,
U.S. Patent Application Publication 2004/0061812 entitled “Liquid Crystal Display Device and Electronic Apparatus” by Maeda.

In addition, T Sergan et al. (p. 514, (P-81) in “Twisted Nematic Reflective Display with Internal Wire Grid Polarizer” SID 2002) describe a wire grid polarizer used inside a reflective liquid crystal cell, simultaneously providing the functions of polarizer, alignment layer and back electrode.

It is known to use different types of polarizers with an LC display in order to achieve specific effects, depending on how the display is used. For example, U.S. Pat. No. 6,642,977 entitled “Liquid Crystal Displays with Repositionable Front Polarizers” to Kotchick et al. discloses a liquid crystal display module for a portable device, wherein the front polarizer may be any of a number of types and can be tilted or positioned suitably for display visibility. Similarly, U.S. Patent Application Publication No. 2003/0016316 entitled “Interchangeable Polarizers for Electronic Devices Having a Liquid Crystal Display” by Sahouani et al. discloses a device arrangement in which different types of front polarizers may be removably interchanged in order to achieve a suitable display effect. Among possible arrangements noted in both the '977 Kotchick et al. and the '16316 Sahouani et al. disclosures is the use of a reflective polarizer as the front polarizer for an LC display. It is significant to note that both the '977 Kotchick et al. and the '16316 Sahouani et al. disclosures emphasize that this arrangement would not be desirable in most cases, except where special “metallic” appearance effects, not related to increased brightness and efficiency, are deliberately intended. As both the '977 Kotchick et al. and the '16316 Sahouani et al. disclosures show, established practice teaches the use of reflective polarizer 52b between the illumination source, backlight 56, and rear polarizer 50b, as is shown in the arrangements of FIGS. 2A-2D, for improved brightness and efficiency. Established practice clearly does not use reflective polarizer 52b on the viewing side of LC component 54a/54b, except, where a “metallic-looking” display appearance is desired, as a less desirable substitute for front polarizer 50a. The use of a reflective polarizer for the front polarizer causes a dramatic loss in contrast ratio, effectively eliminating any possible benefit in increased brightness.

The conventional use of reflective polarizers shown in FIGS. 2A-2D, placed between the illumination source and the rear polarizer as described in the patent literature cited above, provides a measure of increased efficiency and brightness for LC displays. However, in order to use LC displays in a broader range of applications, there is a recognized need for improvement in display brightness, without adding cost or complexity to existing designs.

### SUMMARY OF THE INVENTION

It is an object of the present invention to provide an LC display having increased brightness and efficiency. With this object in mind, the present invention provides an LC display comprising:
(a) a backlight unit for providing substantially unpolarized illumination;
(b) a rear polarizer disposed proximate the backlight unit for receiving the incident substantially unpolarized illumination and transmitting substantially polarized illumination;
(c) an LC spatial light modulator for forming a display beam by selective, pixel-wise modulation of the polarization of the substantially polarized illumination; and,
(d) a reflective polarizer disposed between the LC spatial light modulator and a front polarizer, the reflective polarizer reflecting a portion of dark state light back toward the backlight unit.

It is a feature of the present invention that a reflective polarizer is deployed in the image display beam for reflecting dark state light for reuse.

It is an advantage of the present invention that it provides incremental improvement in LC display brightness and efficiency over conventional designs.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1A is a schematic diagram showing, from a cross-sectional side view, an LC component of an LCD display in a light state having a front polarizer and a rear polarizer;

FIG. 1B is a schematic diagram showing, from a cross-sectional side view, an LC component of an LCD display in a dark state having a front polarizer and a rear polarizer;

FIG. 1C is a schematic diagram showing, from a cross-sectional side view, an LC component of an LCD display in a light state having a front polarizer and a rear polarizer and handling ambient light;

FIG. 1D is a schematic diagram showing, from a cross-sectional side view, an LC component of an LCD display in a dark state having a front polarizer and a rear polarizer and handling ambient light;

FIG. 2A is a schematic diagram showing, from a cross-sectional side view, an LC component of an LCD display in a light state having a front polarizer and a rear polarizer and a reflective polarizer in a conventional arrangement;

FIG. 2B is a schematic diagram showing, from a cross-sectional side view, an LC component of an LCD display in a dark state having a front polarizer and a rear polarizer and a reflective polarizer in a conventional arrangement;

FIG. 2C is a schematic diagram showing, from a cross-sectional side view, an LC component of an LCD display in a light state having a front polarizer and a rear polarizer and a reflective polarizer in a conventional arrangement, for handling ambient light;

FIG. 2D is a schematic diagram showing, from a cross-sectional side view, an LC component of an LCD display in a dark state having a front polarizer and a rear polarizer and a reflective polarizer in a conventional arrangement, for handling ambient light;

FIG. 3A is a schematic diagram showing, from a cross-sectional side view, an LC component of an LCD display in a light state having a front polarizer and a rear polarizer and a reflective polarizer between the front polarizer and the LC component according to the first embodiment of the present invention;

FIG. 3B is a schematic diagram showing, from a cross-sectional side view, an LC component of an LCD display in a dark state having a front polarizer and a rear polarizer and a reflective polarizer between the front polarizer and the LC component according to the first embodiment of the present invention;

FIG. 3C is a schematic diagram showing, from a cross-sectional side view, an LC component of an LCD display in a light state having a front polarizer and a rear polarizer and a reflective polarizer between the front polarizer and the LC component according to the first embodiment of the present invention, for handling ambient light;

FIG. 3D is a schematic diagram showing, from a cross-sectional side view, an LC component of an LCD display in a dark state having a front polarizer and a rear polarizer and a reflective polarizer between the front polarizer and the LC component according to the first embodiment of the present invention, for handling ambient light;

FIG. 3E is a schematic diagram showing, from a cross-sectional side view, an LC component of an LCD display in a light state having a front polarizer and a rear polarizer and a reflective polarizer between the front polarizer and the LC layer according to a comparative example;

FIG. 3F is a schematic diagram showing, from a cross-sectional side view, an LC component of an LCD display in a dark state having a front polarizer and a rear polarizer and a reflective polarizer between the front polarizer and the LC layer according to a comparative example;

FIG. 3G is a schematic diagram showing, from a cross-sectional side view, an LC component of an LCD display in a light state having a front polarizer and a rear polarizer and a reflective polarizer between the front polarizer and the LC layer according to another embodiment of the present invention;

FIG. 3H is a schematic diagram showing, from a cross-sectional side view, an LC component of an LCD display in a dark state having a front polarizer and a rear polarizer and a reflective polarizer between the front polarizer and the LC layer according to another embodiment of the present invention;

FIGS. 4A-4D are schematic diagrams showing, from a cross-sectional side view, another embodiment of the present invention, also using a second reflective polarizer between the rear polarizer and the backlight unit;

FIGS. 5A-5D are schematic diagrams showing, from a cross-sectional side view, a comparative example having a reflective polarizer without the front polarizer for backlight and ambient light;

FIG. 6 is a set of cross-sectional side views showing the nomenclature, symbols, and behavior for components of the present invention;

FIG. 7A is a top view showing a pattern of pixels for a typical image;

FIG. 7B is a schematic diagram showing, from a cross-sectional side view, two adjacent LC components, one in an off state, one in an on state;

FIGS. 8A-8C are graphs showing the relative efficiency gain based on the overall proportion of dark to light pixels;

FIG. 9 is a table showing calculated values of gain relative to transmittance, using the method of the present invention;

FIG. 10 shows a schematic block diagram of components used for brightness control in one embodiment; and,

FIG. 11 shows a flow chart of the logic used to adapt backlighting unit brightness based on overall image brightness.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The apparatus and method of the present invention obtain improved efficiency and brightness from an LCD display by using one or more reflective polarizers to recycle dark state light.

### First Embodiment

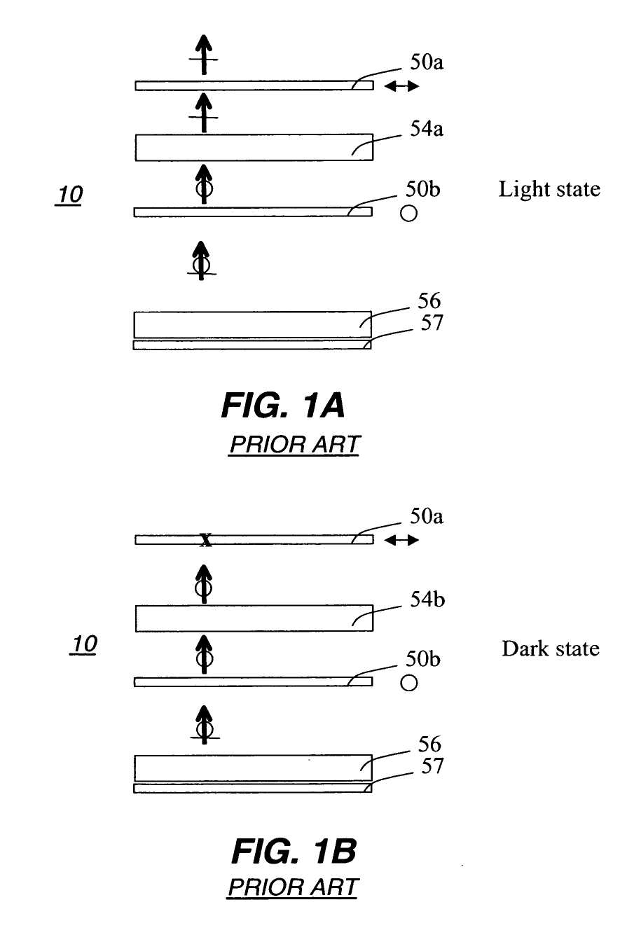

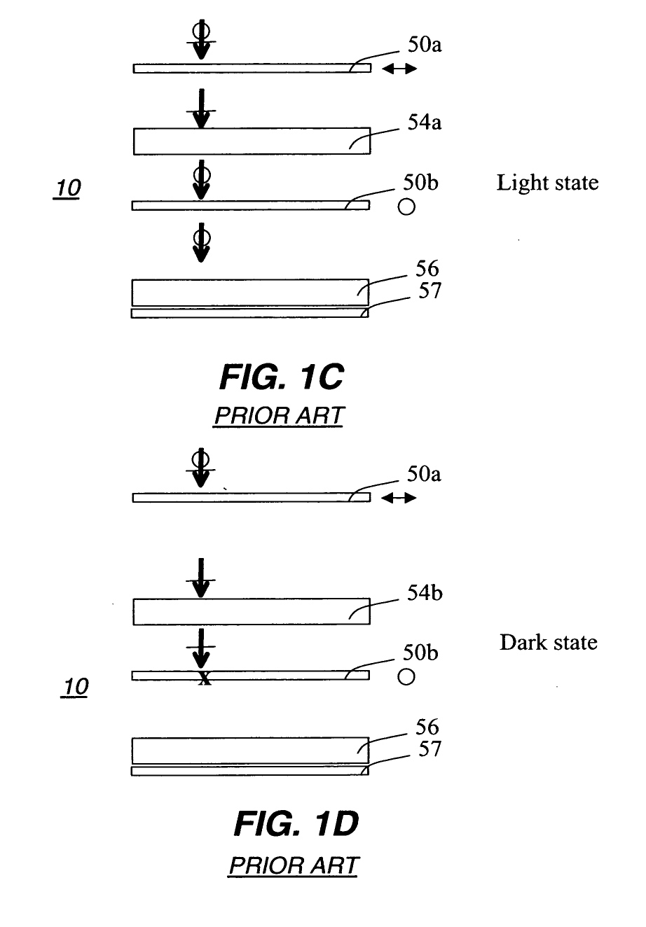

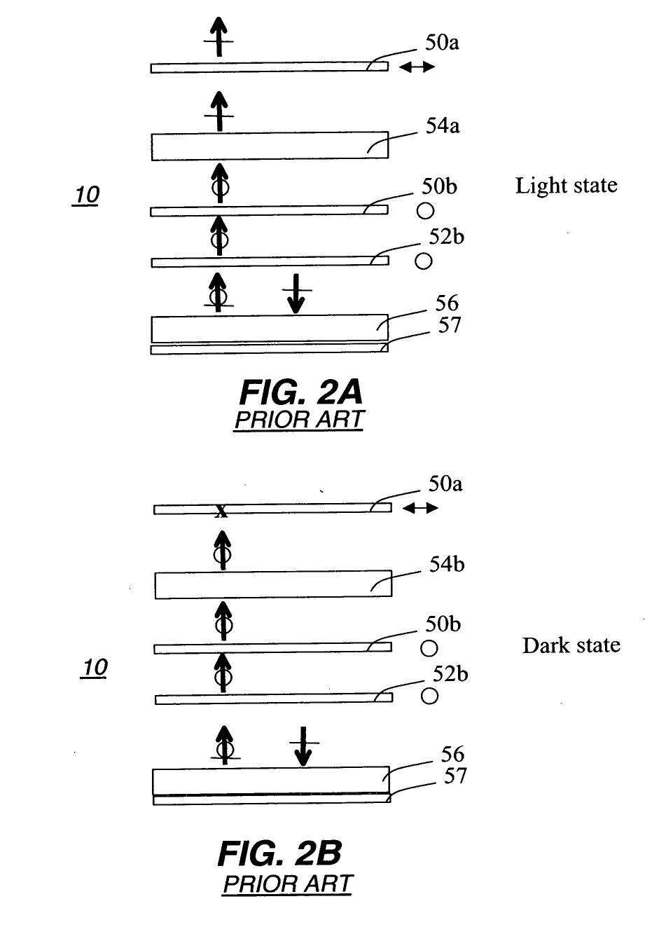

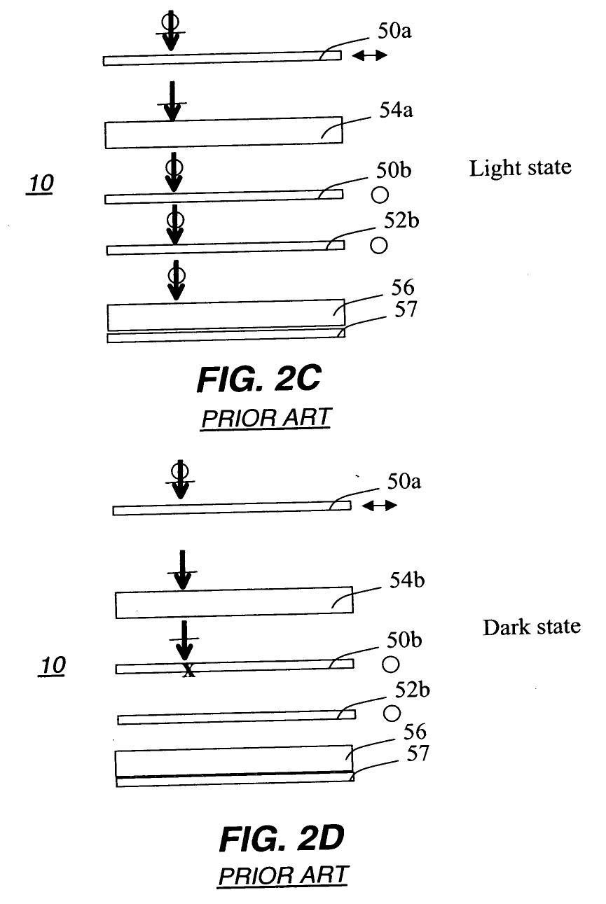

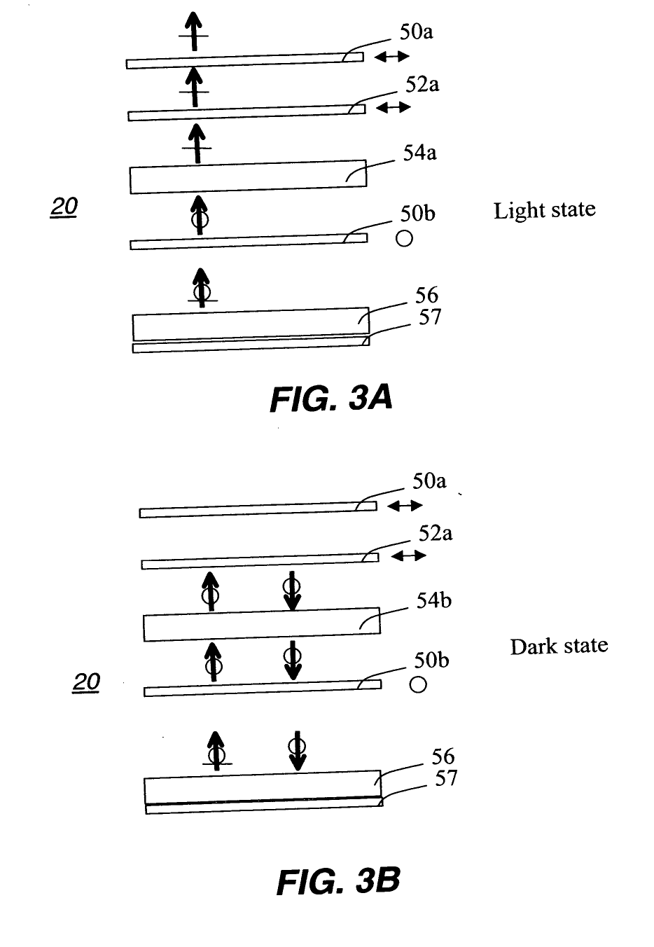

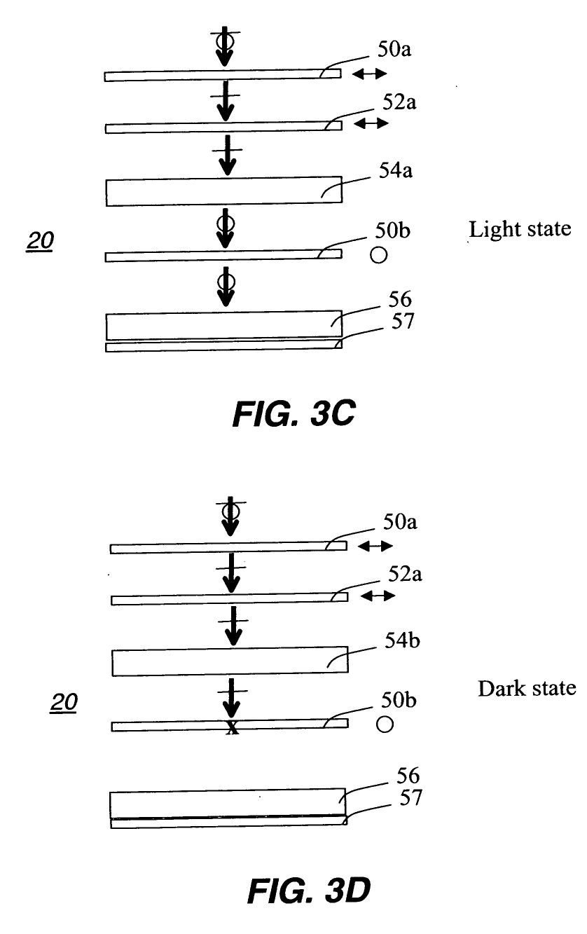

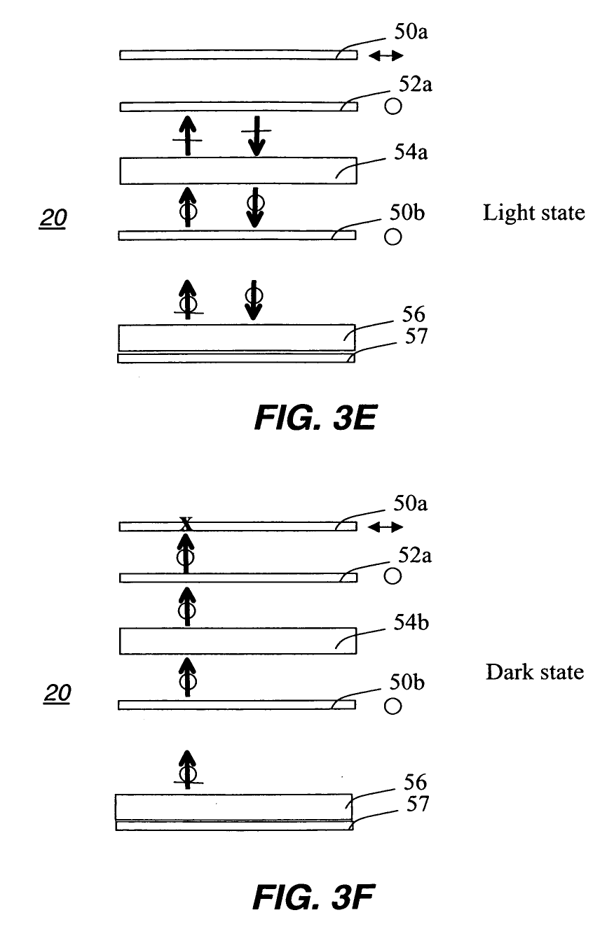

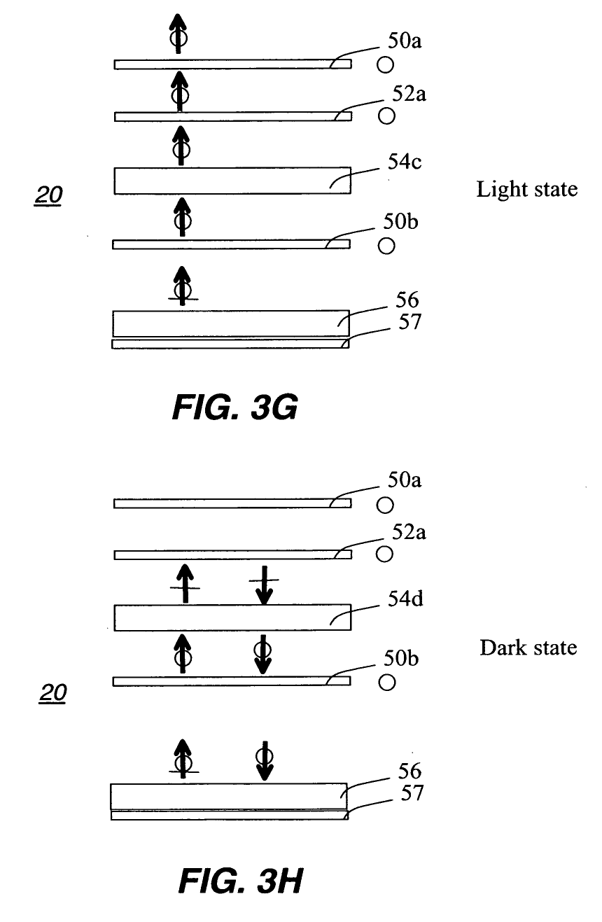

Referring to FIGS. 3A and 3B, there is shown, for light and dark states respectively, an embodiment of the present invention for an LCD display 20, in which reflective polarizer 52a is disposed between LC component 54a/54b and front polarizer 50a. Here, the transmission axes of rear and front polarizers 50b and 50a are perpendicular to each other, within ±10 degrees. Following the convention described with reference to FIGS. 1A-1D and 2A-2D, the LC off state converts P-polarization to S-polarization, and S- to P-polarization. The transmission axis of reflective polarizer 52a is parallel to the transmission axis of front polarizer 50a. Recycled light from reflective polarizer 52a has an orthogonal polarization with respect to front polarizer 50a.

FIG. 3A shows how LC display 20 handles light in the light state. Unpolarized light from backlight unit 56 is incident to rear polarizer 50b that transmits light having S-polarization, absorbing the P-polarization component. Off state LC component 54a rotates the light polarization to provide output light having P-polarization. This light is then transmitted through both reflective polarizer 52a and front polarizer 50a. Thus, in the light state, reflective polarizer 52a simply transmits the intended light.

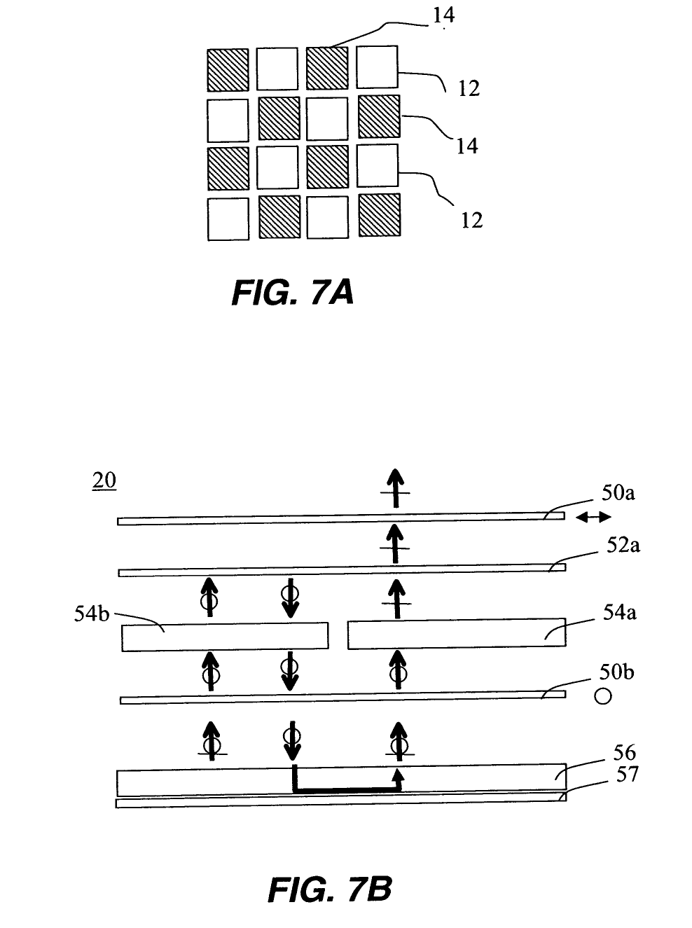

FIG. 3B shows how LC display 20 handles light in the dark state. On state LC component 54b performs no rotation of light polarization. Recalling FIGS. 1B and 2B, light having S-polarization must be absorbed by front polarizer 50a in the dark state. With the novel arrangement of FIGS. 3A-3B, however, reflective polarizer 52a reflects any light having S-polarization back toward backlight unit 56. This behavior has a recycling effect, allowing this dark state light to be reused for light state pixels. FIG. 7B shows the combined behavior of LCD display 20 for adjacent off state LC component 54a and on state LC component 54b.

FIGS. 3C and 3D show the behavior of LC display 20 for ambient light. As was described with reference to FIGS. 1C-1D and 2C-2D, front polarizer 50a absorbs light having S-polarization and transmits light having P-polarization. Reflective polarizer 52a transmits this light in the same way as does front polarizer 50a, so that there is essentially no change to ambient light handling from that shown in FIGS. 1C-1D and 2C-2D. Thus, it can be seen that by positioning reflective polarizer 52a between LC component 54a/54b and front polarizer 50a, some portion of dark state light is recycled and there is no added contrast degradation due to ambient light.

In the configuration of FIGS. 3A-3D, the transmission axis of reflective polarizer 52a is parallel to the transmission axis of front polarizer 50a. FIGS. 3E and 3F show an alternate case, in which the transmission axis of reflective polarizer 52a is orthogonal to the transmission axis of front polarizer 50a. Following the light path and polarization states indicated, it can be seen that this arrangement is not suitable. In the light state, light having P-polarization is reflected from reflective polarizer 52a, rather than being emitted. In the dark state, light having S-polarization is absorbed by front polarizer 50a instead of being reflected back for re-use. Thus, it can be seen that the transmission axis of reflective polarizer 52a must match the transmission axis of front polarizer 50a, within ±10 degrees.

### Second Embodiment

In the inventive embodiment of FIGS. 3G and 3H, the transmission axes of front and rear polarizers 50a and 50b are parallel to each other, within ±10 degrees. This arrangement may be suitable where on state and off state behavior of LC component 54c/54d is reversed from that of the preceding examples of FIGS. 1A-3F. Here, off state LC component 54c does not change the polarization of incident light; on state LC component 54d rotates the polarization of incident light. With this optional arrangement, the transmission axis of reflective polarizer 52a must match the transmission axes of both front and rear polarizers 50a and 50b in order to recycle dark state light as shown in FIG. 3H. As with the first embodiment of FIGS. 3A-3D, the embodiment of FIGS. 3G and 3H does not exhibit added contrast degradation due to ambient light.

### Third Embodiment

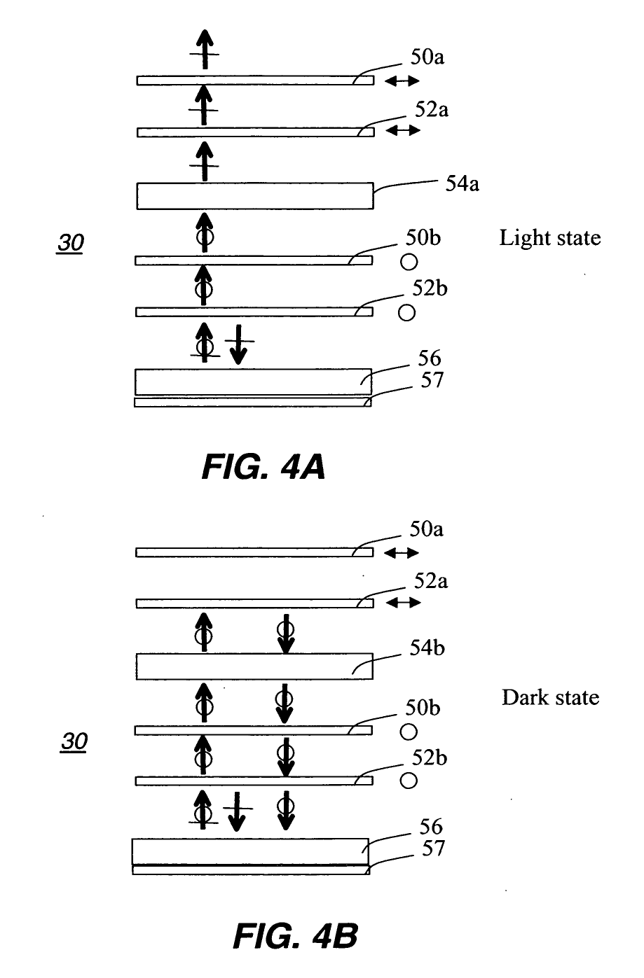

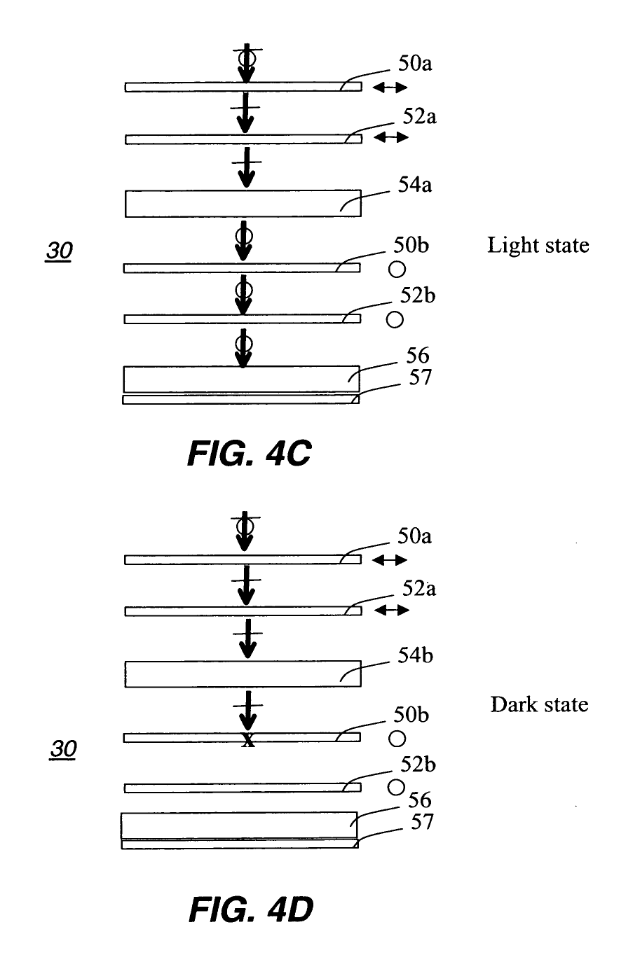

FIGS. 4A-4D show an LCD display 30 in an alternate embodiment. Here, a pair of reflective polarizers 52a and 52b is used to improve brightness and efficiency. The handling of light for light and dark states combines the features of the conventional use of a reflective polarizer shown in FIGS. 2A-2D with the inventive embodiment shown in FIGS. 3A-3D. Unpolarized light from backlight unit 56 is incident to rear reflective polarizer 52a that transmits one polarization (S-polarization in FIGS. 4A-4D) and reflects the orthogonal polarization back to backlight unit 56 for recycling. Rear polarizer 50b transmits light having S-polarization, absorbing any residual P-polarization component. Off state LC component 54a rotates the light polarization to provide output light having P-polarization. This light is then transmitted through both reflective polarizer 52a and front polarizer 50a.

FIG. 4B shows how LC display 30 handles light in the dark state. On state LC component 54b performs no rotation of light polarization. Recalling FIGS. 1B and 2B, light having S-polarization is conventionally absorbed by front polarizer 50a in the dark state. With the novel arrangement of FIGS. 4A-4B, however, reflective polarizer 52a reflects light having S-polarization back toward backlight unit 56. This behavior has a recycling effect, allowing this light to be reused for light state pixels.

FIGS. 4C and 4D shown how LC display 30 handles ambient light, in light and dark states, respectively. In the light state, some of the ambient light having S-polarization may be recycled and reused; ambient light having P-polarization is absorbed by rear polarizer 50b. Thus, the alternate embodiment of FIGS. 4A-4D provides increased brightness and efficiency, without compromising contrast due to ambient light effects.

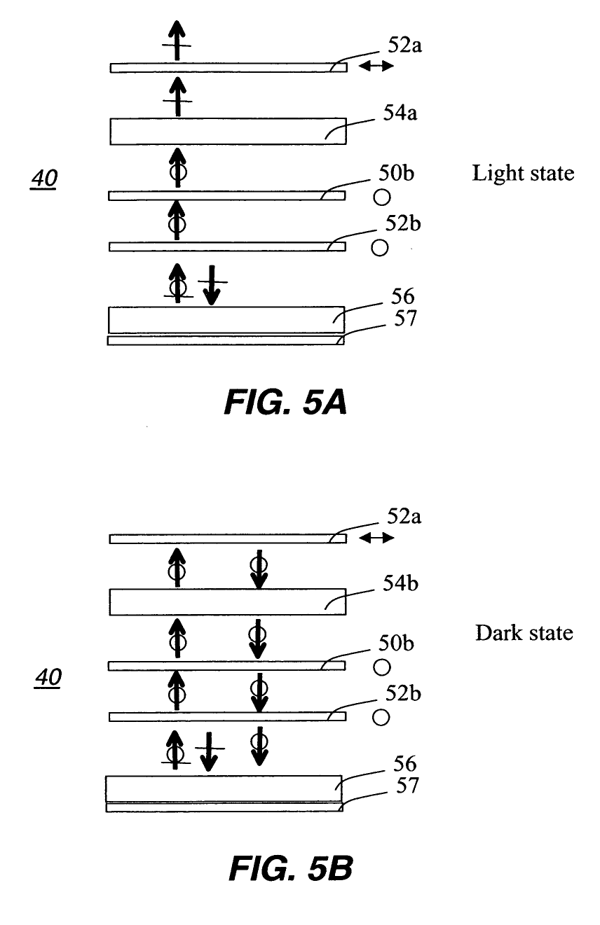

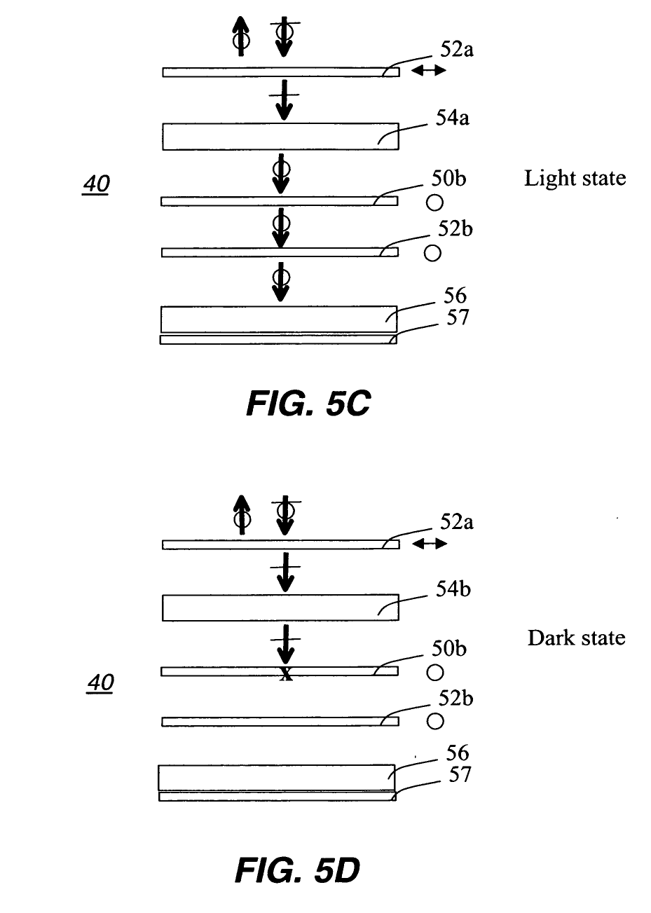

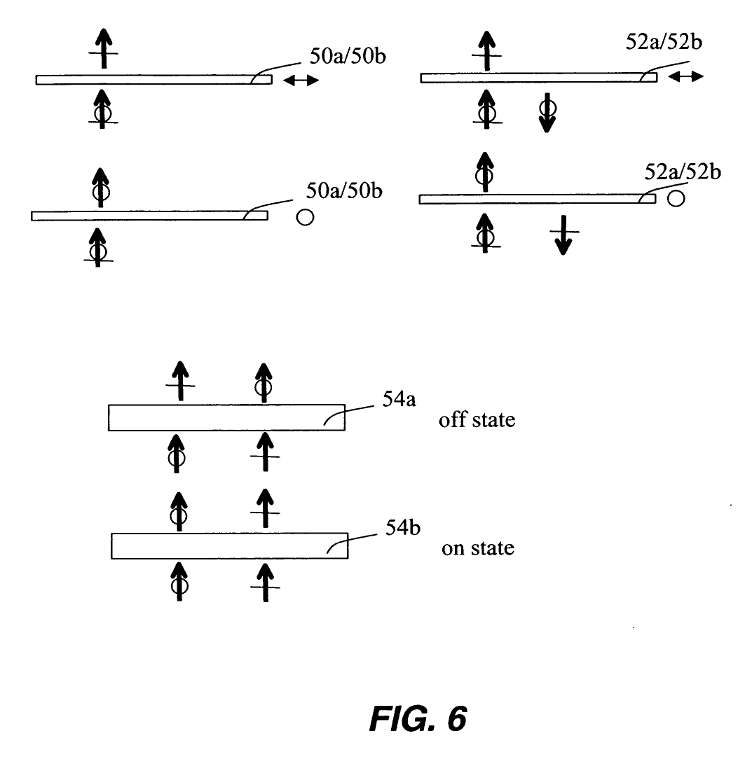

As noted in the background section given above, it has been pointed out that use of a reflective polarizer in place of front polarizer 50a is not advantageous for either brightness or contrast. FIGS. 5A-5D show LCD display 40 in an alternate embodiment with reflective polarizer 52a in this front position and show how ambient light may compromise contrast when this substitution is made. FIGS. 5A and 5B show this alternate arrangement, without front polarizer 50a, such that reflective polarizer 52a is in the front position relative to a viewer. The use of a second, rear reflective polarizer 52b is optional. Light state and dark state behavior is similar to that described with reference to the inventive embodiments of FIGS. 3A-3B and 4A-4B, with some advantageous recycling of dark state light, particularly where the optional rear reflective polarizer 52b is used.

FIGS. 5C and 5D show how LCD display 40 handles ambient light. In either light or dark state, reflective polarizer 52a reflects one polarization component. This reflection dramatically reduces display contrast, since stray light is introduced when a dark state is intended. Thus, while the use of reflective polarizer 52a without front polarizer 50a may offer some aesthetic appeal for providing a “metallic” appearance, this arrangement is not optimal due to contrast degradation.

For the embodiments disclosed herein, additional components may be added to enhance brightness and contrast. For example, a conventional collimating film such as Vikuiti™ Brightness Enhancement Film, manufactured by 3M, St. Paul, Minn. could be added to collimate the illumination. A collimating (or brightness enhancement) film for this purpose would be added to the configuration of FIGS. 3A-4D, typically disposed between backlight unit 56 and LC component 54a/54b. Other known collimating films can be used as well.

Dark State Recycling

Referring to FIG. 7A, there is shown a plan view of a portion of an LCD display 20 with dark pixels 14 and light pixels 12. As FIG. 7A represents, each image formed on LCD display 20 has a percentage of dark pixels 14 and light pixels 12. The apparatus and method of the present invention takes advantage of light that is not needed for dark pixels 14 and redirects a portion of this light to light pixels 12. This behavior is summarized in FIG. 7B which shows how light can be redirected from dark pixel 14, formed by on state LC component 54b, to light pixel 12, formed by off state LC component 54a.

For describing how dark state recycling works in practice, the following variables are defined:
I₀ total flux of light from backlight unit 56
x percentage of dark pixels 14 to the total number of pixels
1-x percentage of light pixels 12 to the total number of pixels
T_{∥} transmittance of an absorptive polarizer (front polarizer 50a and rear polarizer 50b) for light polarized along the transmission axis
T_{lc} transmittance of the liquid crystal layer. As a first approximation, it can be assumed that T_{lc} is the same for both on-state and off-state
T_{f} transmittance of the front reflective polarizer 52a that is placed between front absorptive polarizer 50a and LC component 54a/54b
R_{f} reflectance of front reflective polarizer 52a that is placed between front absorptive polarizer 50a and LC component 54a/54b
Tᵣ transmittance of the rear reflective polarizer 52b that is placed between rear absorptive polarizer 50b and LC component 54a/54b
Rᵣ reflectance of the rear reflective polarizer 52b that is placed between rear absorptive polarizer 50b and LC component 54a/54b
R reflectance of backlight unit 56.

### EXAMPLE 1

### Dark State Light Recycling Without a Conventional Reflective Polarizer

Dark state recycling according to a first embodiment of the present invention can be illustrated by comparing light behavior in FIGS. 3A and 3B to light behavior in the conventional arrangement of FIGS. 1A and 1B.

Without dark state light recycling, as shown in FIG. 1A the total flux of light emitted from light pixels 12, with the percentage being 1-x, is as follows: Iₜₒₜₐₗ₀≈0.5I₀T_{∥}²T_{lc} (1−x)

With dark state light recycling, that is, with reflective polarizer 52a placed between the front absorptive polarizer 50a and LC component 54a or 54b, the flux of light from light pixels 12, with the percentage being 1−x, is approximately 0.5I₀T_{∥}²T_{lc}T_{f} (1−x).

The flux reflected back from dark pixels 14, with the percentage being x, and from backlight unit 56 is approximately 0.5I₀T_{∥}²T_{lc}²R_{f}Rx.

This flux has a probability for being redirected though light pixels 12 of 1−x, and a probability for being redirected to dark pixels 14 of x.

After first recycling, the total flux coming out of light pixels 12 is

$$\begin{matrix}{I}_{total1} \approx 0.5 {I}_{0} {T}_{∥}^{2} {T}_{lc} {T}_{f} ( 1 - x ) + 0.5 {I}_{0} {T}_{∥}^{2} {T}_{lc}^{2} {R}_{f} Rx \cdot 0.5 {T}_{∥}^{2} {T}_{lc} {T}_{f} ( 1 - x ) \\ = 0.5 {I}_{0} {T}_{∥}^{2} {T}_{lc} {T}_{f} ( 1 - x ) [ 1 + 0.5 {T}_{∥}^{2} {T}_{lc}^{2} {R}_{f} Rx ]\end{matrix}$$

After second recycling, the total flux coming out of light pixels 12 is

$$\begin{matrix}{I}_{total2} \approx {I}_{total1} + {( 0.5 {I}_{0} {T}_{∥}^{2} {T}_{lc}^{2} {R}_{f} Rx )}^{2} \cdot 0.5 {I}_{0} {T}_{∥}^{2} {T}_{lc} {T}_{f} ( 1 - x ) \\ = 0.5 {I}_{0} {T}_{∥}^{2} {T}_{lc} {T}_{f} ( 1 - x ) [ 1 + 0.5 {T}_{∥}^{2} {T}_{lc}^{2} {R}_{f} Rx + {( 0.5 {T}_{∥}^{2} {T}_{lc}^{2} {R}_{f} Rx )}^{2} ]\end{matrix}$$

The total flux coming out of light pixels 12, then, is

$$\begin{matrix}{I}_{DS} \approx 0.5 {I}_{0} {T}_{∥}^{2} {T}_{lc} {T}_{f} ( 1 - x ) [ 1 + 0.5 {T}_{∥}^{2} {T}_{lc}^{2} {R}_{f} Rx + {( 0.5 {T}_{∥}^{2} {T}_{lc}^{2} {R}_{f} Rx )}^{2} + … ] \\ = 0.5 {I}_{0} {T}_{∥}^{2} {T}_{lc} ( 1 - x ) \frac{{T}_{f}}{1 - 0.5 {T}_{∥}^{2} {T}_{lc}^{2} {R}_{f} Rx}\end{matrix}$$

The gain is defined as

$${Gain}_{DS} = \frac{{I}_{DS}}{{I}_{total0}} - 1 = \frac{{T}_{f}}{1 - 0.5 {T}_{∥}^{2} {T}_{lc}^{2} {R}_{f} Rx} - 1$$

In an ideal case, T_{∥}, T_{lc}, T_{f}, R_{f}, and R are all equal to 1, thus

$$Gain = \frac{1}{1 - 0.5 x} - 1$$

The maximum gain is 100% when x approaches 100%. The gain is 33% when x=50%. The gain is 0% when x=0%. The maximum gain of 100% is limited by rear polarizer 50b, which absorbs half of the light when the dark state light is recycled on each path.
Let f=T_{∥}²T_{lc}²R_{f}R, then

$${Gain}_{DS} = \frac{{T}_{f}}{1 - 0.5 fx} - 1$$

In practice, T_{∥}≅0.95, T_{lc}≅0.95, T_{f}≅0.9, R_{f}≅0.95, R≅0.9. f≅0.7.

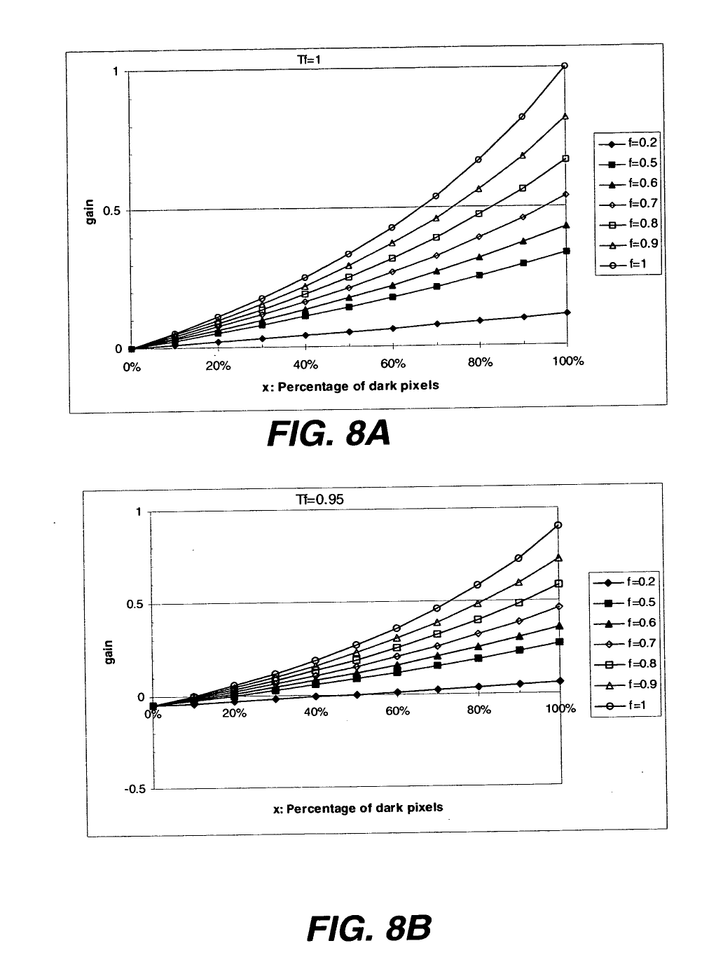

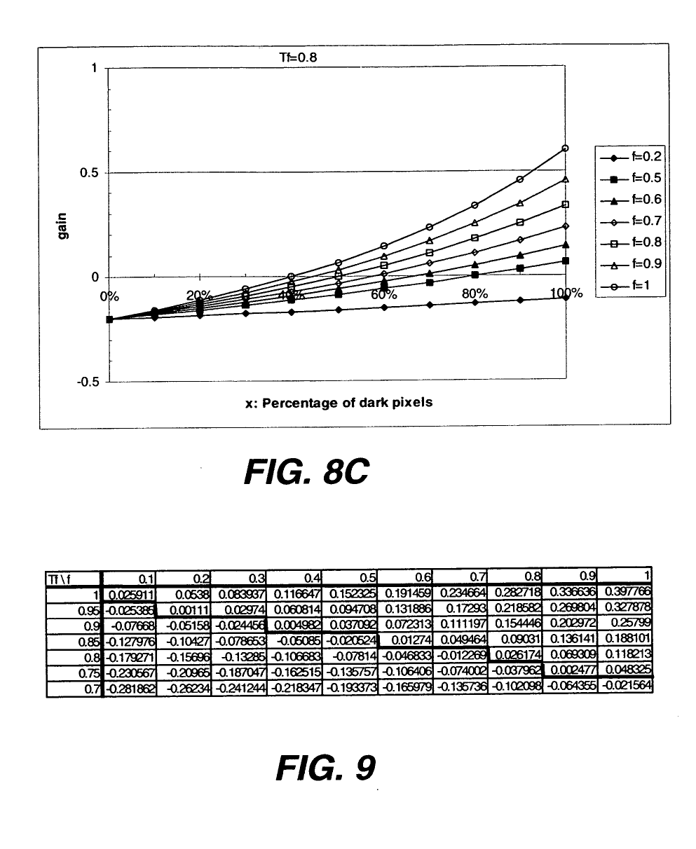

FIGS. 8A, 8B, and 8C show gain vs percentage of dark pixels 14 x for a transmittance T_{f} of reflective polarizer 52a at 100%, 95%, and 80%, respectively. In all cases, for given percentage of dark pixels 14, the higher the factor f, the higher the gain. At a fixed f, the higher the percentage of dark pixels 14, the higher the gain.

As shown in FIG. 8A, when the transmittance T_{f} of reflective polarizer 52a is 100%, the gain is always positive independent of the factor f and the percentage of dark pixels 14, x. When f=1 in an ideal case and x approaches 100%, the gain is 100%.

Referring to FIG. 8B, when the transmittance T_{f} of reflective polarizer 52a is less than 100%, here about 95%, the gain can be negative for small x, which indicates that there can be actual loss in light efficiency for an image with a small number of dark pixels 14 (or, conversely, with a large number of light pixels 12). But for an image with a large number of dark pixels 14 (or a small number of light pixels 12), i.e, a large x, the gain is positive.

Referring to FIG. 8C, when the transmittance T_{f} of reflective polarizer 52a is low enough, for example, 80%, the gain can be negative for all x between 0 and 1 for a small f (for example, f=0.2). But for a reasonably designed LCD system, in general, f≧0.7. The curve corresponding to f=0.7 shows a positive gain when the percentage of dark pixels x≧0.6.

Thus, it can be observed that dark state light recycling gain depends on the image shown on the display. To further quantify the gain, an average gain over x from 0 to 1 with equal weight is calculated at various f and T_{f} values. The average gain is shown in the table of FIG. 9. In order to have positive gain rather than loss, the factors f and T_{f} should obtain a value within the upper triangle of this table. For example, when T_{f}=0.75 and f≧0.9, the average gain is positive. When T_{f}=0.9 and f≧0.4, the average gain is also positive. When T_{f}=0.9 and f=0.7, the average gain is about 11%. The ranges of values f and T_{f} may vary when different criteria are adopted. The gain in light efficiency may also vary with the image pattern distribution rather than simply with the raw percentage of dark pixels 14. Overall, the transmittance of the reflective polarizer is preferably greater than 75% at the wavelength of interest.

### EXAMPLE 2

### Dark State Light Recycling in Combination with a Conventional Reflective Polarizer

Dark state recycling according to another embodiment of the present invention can be illustrated by comparing light behavior in FIGS. 4A and 4B to light behavior in the conventional arrangement of FIGS. 2A and 2B.

Referring to FIGS. 2A and 2B, without dark state light recycling and with conventional polarization recycling done by the reflective polarizer 52b, the total flux of light emitted from light pixels 12, with the percentage being 1−x, is

$${I}_{total}^{RP} \approx 0.5 {I}_{0} {T}_{∥}^{2} {T}_{lc} ( 1 - x ) \frac{{T}_{r}}{1 - 0.5 {R}_{r} R} \leq 2 {I}_{total0}$$

Referring to FIGS. 4A and 4B, additional dark state light recycling takes place with reflective polarizer 52a placed between front absorptive polarizer 50a and LC component 54a or 54b, total flux coming out of light pixels 12, with the percentage being

$$1 - x , is {I}_{DS}^{RP} \approx 0.5 {I}_{0} {T}_{∥}^{2} {T}_{lc} ( 1 - x ) \frac{{T}_{r}}{1 - 0.5 {R}_{r} R} \frac{{T}_{f}}{1 - {T}_{∥}^{2} {T}_{lc}^{2} {R}_{f} Rx} .$$

The gain compared to the case with polarization recycling by a conventional reflective polarizer is defined as

$${Gain}_{DS}^{RP} = \frac{{I}_{DS}^{RP}}{{I}_{total}^{RP}} - 1 \approx \frac{1}{1 - {T}_{∥}^{2} {T}_{lc}^{2} {R}_{f} Rx} - 1$$

In an ideal case, T_{∥}, T_{lc}, T_{f}, R_{f}, and R are all equal to 1, thus

$${Gain}_{DS}^{RP} = \frac{1}{1 - x} - 1.$$

Thus, ideally, the maximum gain has no upper limit when x approaches 100%. The gain is 100% when x=50%. The gain is 0% when x=0%.
Let f T_{∥}²T_{lc}²R_{f}R, then

$${Gain}_{DS}^{RP} = \frac{{T}_{f}}{1 - fx} - 1$$

In practice, T_{∥}≅0.95, T_{lc}≅0.95, T_{f}≅0.9, R_{f}≅0.95, R≅0.9. f≅0.7.
In this case, Gain_{DS}^{RP}=200% when x approaches 100%. Gain_{DS}^{RP}=38% when x=50%.
LCD System

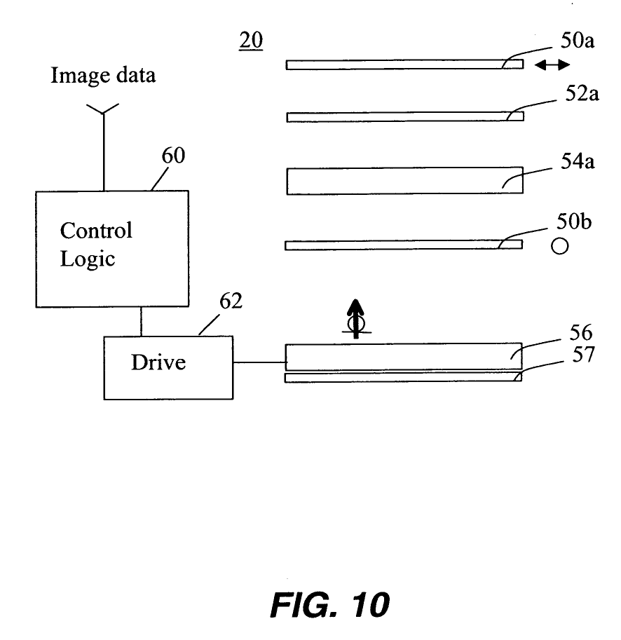

Recycling dark state light according to the present invention provides the light state pixels of the LCD with more light than the same pixels would receive for a conventional display without dark state light recycling. As is noted in the description given above, the incremental amount of added brightness depends, in part, on the percentage x of dark pixels. In some cases, it may be preferable to maintain a consistent level of pixel brightness for a given pixel data value, regardless of the percentage x of dark pixels. The present invention also provides an apparatus and method for maintaining this consistent brightness behavior by dynamically adjusting the source brightness of backlight unit 56 based on the percentage x of dark pixels. Referring to the block diagram of FIG. 10, there are shown the additional components provided for brightness control. A control logic processor 60 receives the image data and calculates the percentage x of dark pixels. Based on this calculation, control logic processor 60 modulates the signal to a drive circuit 62 that provides a variable signal to backlight unit 56. The light source provides an output that can be controlled. The light source for backlight unit 56 may be a light emitting diode (LED), an array of LEDs, or some other type of light source having sufficiently fast intensity response to a changing drive signal.

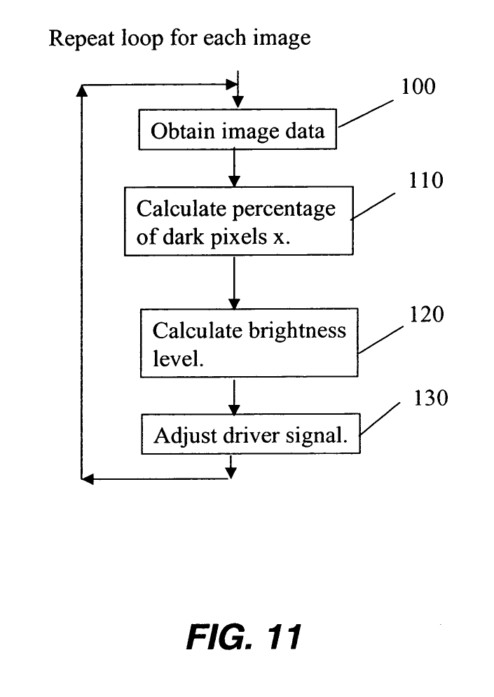

The control logic for brightness adjustment is straightforward, as is shown in the example block diagram of FIG. 11. For each image, image data is accessed in an obtain data step 100. A dark percentage calculation step 110 is then executed, in which percentage x of dark pixels is calculated from this data. Based on this calculation a brightness level calculation step 120 is executed, in which control logic computes a new brightness level, using an equation or using a look-up table, for example. Based on this calculated drive value, a drive signal adjustment step 130 is executed, directing this value to drive circuit 62, as an analog or digital signal. The control logic of FIG. 11 can be used for an individual image or used as a control loop, repeated for each of a succession of images.

Reflective Polarizer Types

The apparatus and method of the present invention can use a number of different types of reflective polarizer, including a wire-grid polarizer (available from Moxtek, Inc., Orem, Utah), a circular polarizer such as a cholesteric liquid crystal component with a quarter-wave retarder, or a multilayer interference-based polarizer such as Vikuiti™ Dual Brightness Enhancement Film, manufactured by 3M, St. Paul, Minn. In the wire-grid polarizer, thin wires are formed on a glass substrate. Wires can be faced toward the liquid crystal layer, functioning as electrode, alignment, and reflective polarizer. Wires can also be faced toward the front polarizer. Other known reflective polarizers can also be used. The reflective polarizer can be coupled to the surface of the liquid crystal spatial light modulator, meaning that the reflective polarizer and the liquid crystal light modulator share a common substrate. The reflective polarizer can be placed inside or outside of the substrate.

For best performance, reflective polarizers should present as little retardance as possible, so as not to cause adverse effects to either light or dark state pixels. If there is retardance, the optical axis of the substrate is best arranged either parallel or perpendicular to the transmission axis of the reflective polarizer. It is also possible to incorporate compensation films as known in the art to improve viewing angle, contrast, and color purity of the reflective polarizers.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, light state and dark state behaviors of LC spatial light modulators can be reversed, as was shown with respect to FIGS. 3G and 3H. The use of reflective polarizer 52a between front and rear polarizers 50a and 50b necessitates some changes to the design of these other polarizing components, as can be well appreciated by those skilled in the optical arts. Reflective polarizer 52a can alternately be incorporated onto the surface of LC component 52a/52b, so that the spatial light modulator itself includes this reflective polarization component.

Thus, what is disclosed is an LCD display using a reflective polarizer to recycle dark state light, providing improved efficiency and brightness.

1. A liquid crystal display comprising:
(a) a backlight unit for providing substantially unpolarized illumination;
(b) a rear polarizer disposed proximate the backlight unit for receiving the incident substantially unpolarized illumination and transmitting substantially polarized illumination;
(c) a liquid crystal spatial light modulator for forming a display beam by selective, pixel-wise modulation of the polarization of the substantially polarized illumination; and,
(d) a reflective polarizer disposed between the liquid crystal spatial light modulator and a front polarizer, the reflective polarizer reflecting a portion of dark state light back toward the backlight unit.

2. A liquid crystal display according to claim 1 wherein the reflective polarizer is coupled to the surface of the liquid crystal spatial light modulator.

3. A liquid crystal display according to claim 1 wherein the transmittance of the reflective polarizer is greater than 75%.

4. A liquid crystal display according to claim 1 further comprising an additional reflective polarizer disposed between the rear polarizer and the backlight unit.

5. A liquid crystal display according to claim 1 further comprising a collimating film disposed between the rear polarizer and the backlight unit.

6. A liquid crystal display according to claim 1 further comprising a compensation film.

7. A liquid crystal display according to claim 1 wherein the respective transmission axes of the front and rear polarizers are parallel to each other within ±10 degrees.

8. A liquid crystal display according to claim 1 wherein the respective transmission axes of the front and rear polarizers are orthogonal to each other within ±10 degrees.

9. A liquid crystal display according to claim 1 wherein the respective transmission axes of the front and reflective polarizers are parallel to each other within ±10 degrees.

10. A liquid crystal display according to claim 1 wherein the reflective polarizer is a wire grid polarizer.

11. A liquid crystal display according to claim 1 wherein the reflective polarizer comprises a multilayer interference-based polarizer.

12. A liquid crystal display according to claim 1 wherein the reflective polarizer comprises a circular polarizer with a quarter wave retarder.

13. A liquid crystal display according to claim 1 wherein the backlight unit comprises at least one light source with an output that can be controlled.

14. A liquid crystal display according to claim 13 wherein the light source comprises one or more light emitting diode.

15. A liquid crystal display comprising:
(a) a backlight unit providing substantially unpolarized illumination;
(b) a first reflective polarizer, having a transmission axis, for
(i) transmitting that portion of light from the substantially unpolarized backlight unit illumination that has polarization parallel to the transmission axis; and,
(ii) reflecting light having a polarization orthogonal to the transmission axis;
(c) a rear polarizer for receiving the polarized light transmitted from the first reflective polarizer;
(d) a liquid crystal spatial light modulator for forming an image by selective, pixel-wise modulation of polarization of the polarized illumination; and,
(e) a second reflective polarizer disposed between the liquid crystal spatial light modulator and a front polarizer for reflecting a portion of dark state light from the liquid crystal spatial light modulator back toward the backlight unit.

16. A liquid crystal display according to claim 15 wherein the second reflective polarizer is coupled to the surface of the LC spatial light modulator.

17. A liquid crystal display according to claim 15 wherein the transmittance of the second reflective polarizer is greater than 75%.

18. A liquid crystal display according to claim 15 further comprising a collimating film disposed between the rear polarizer and the backlight unit.

19. A liquid crystal display according to claim 15 further comprising a compensation film.

20. A liquid crystal display according to claim 15 wherein the respective transmission axes of the front and rear polarizers are parallel to each other within ±10 degrees.

21. A liquid crystal display according to claim 15 wherein the respective transmission axes of the front and rear polarizers are orthogonal to each other within ±10 degrees.

22. A liquid crystal display according to claim 15 wherein the respective transmission axes of the front polarizer and second reflective polarizer are parallel to each other within ±10 degrees.

23. A liquid crystal display according to claim 15 wherein the first reflective polarizer is a wire grid polarizer.

24. A liquid crystal display according to claim 15 wherein the second reflective polarizer is a wire grid polarizer.

25. A liquid crystal display according to claim 15 wherein the second reflective polarizer comprises a multilayer interference-based polarizer.

26. A liquid crystal display according to claim 15 wherein the second reflective polarizer comprises a circular polarizer with a quarter wave retarder.

27. A liquid crystal display according to claim 15 wherein the backlight unit comprises at least one light source with an output that can be controlled.

28. A liquid crystal display according to claim 27 wherein the light source comprises one or more light emitting diode.

29. A method for adjusting display brightness comprising:
a) providing backlight illumination to a transmissive liquid crystal display component;
b) forming an image beam by pixel-wise modulation of the polarization of the backlight illumination according to image data;
c) disposing a reflective polarizer in the path of the image beam;
d) determining, based on the image data, the relative proportion of dark pixels to light pixels; and,
e) modulating the backlight illumination brightness level based on the relative proportion of dark to light pixels for the displayed image.

30. A method according to claim 29 wherein the step of modulating the backlight illumination brightness level comprises the step of varying the drive current to a light source that can be controlled.

31. A method according to claim 29 wherein the light source comprises one or more LEDs.
